(19) United States
(12) Patent Application Publication
(10) Pub. No.: US 2017/0177059 A1
(43) Pub. Date: Jun. 22, 2017

(54) POWER MANAGING METHOD AND ELECTRONIC SYSTEM APPLYING THE POWER MANAGING METHOD

(71) Applicant: MEDIATEK INC., Hsin-Chu (TW)

(72) Inventors: Chen-Wei Fan, Taoyuan City (TW); Yong-Sheng Lo, Taichung City (TW); Jen-Chieh Yang, Hsinchu City (TW); Shi-Rui Lee, Taoyuan City (TW)

(21) Appl. No.: 15/399,716

(22) Filed: Jan. 5, 2017

Related U.S. Application Data
(63) Continuation-in-part of application No. 14/937,895, filed on Nov. 11, 2015.
Application No. 14/937,895 is a continuation-in-part of application No. PCT/CN2015/076525, filed on Apr. 14, 2015.
(60) Provisional application No. 62/174,168, filed on Jun. 11, 2015.
(60) Provisional application No. 62/158,061, filed on May 7, 2015.
(60) Provisional application No. 62/132,674, filed on Mar. 13, 2015.
(60) Provisional application No. 61/981,294, filed on Apr. 18, 2014.

(51) Int. Cl. G06F 1/32

(52) U.S. Cl. CPC G06F 1/329; G06F 1/3228

(57) ABSTRACT

Disclosed is a power managing method applied to an electronic system comprising a power providing device. The power managing method comprises: (a) receiving a power reference parameter provided by a user; and (b) displaying a candidate disabling list, which lists at least one application program, according to the power reference parameter and an available power budget of the power providing device. At least one of the application programs listed in the candidate disabling list can be selected and disabled.

### CROSS REFERENCE TO RELATED APPLICATION

This application is a continuation-in-part application of applicant's earlier application, Ser. No. 14/937,895, filed 2015 Nov. 11. Also, the earlier application Ser. No. 14/937,895 is a continuation-in-part application of applicant's earlier application, Serial No. PCT/CN2015/076525, filed 2015 Apr. 14, which claims the benefit of U.S. Provisional Application No. 61/981,294, filed on Apr. 18, 2014. Besides, the earlier application Ser. No. 14/937,895 claims the benefit of U.S. Provisional Application No. 62/132,674 filed on Mar. 13, 2015, U.S. Provisional Application No. 62/158,061 filed on May 7, 2015, and U.S. Provisional Application No. 62/174,168 filed on Jun. 11, 2015. The contents of the earlier applications are incorporated herein by reference.

### BACKGROUND

In recent years, a smart electronic apparatus such as a smart phone, a plate computer, or a smart watch becomes more and more powerful. Accordingly, the power consumption for such smart electronic apparatus is high and a good power managing method is needed.

However, for a conventional power managing method, if the user desires to reduce the power consumption for the smart electronic apparatus via stopping application programs, the user needs to manually select which application programs should be disabled. If the application programs are not well selected, the smart electronic apparatus may operate non-smoothly or the maintaining time period for the battery may be shorter than expected.

### SUMMARY

Accordingly, one objective of the present disclosure is to provide a power managing method by which a user can efficiently disable application programs.

Another objective of the present disclosure is to provide an electronic apparatus by which a user can efficiently disable application programs.

One embodiment of the present disclosure is to provide a power managing method applied to an electronic system comprising a power providing device. The power managing method comprises: (a) receiving a power reference parameter provided by a user; and (b) displaying a candidate disabling list, which lists at least one application program, according to the power reference parameter and an available power budget of the power providing device. At least one of the application programs listed in the candidate disabling list can be selected and disabled.

Another embodiment of the present disclosure is to provide an electronic apparatus comprising a power providing device and a control unit. The control unit is configured to receive a power reference parameter provided by a user, and configured to control a display to display a candidate disabling list, which lists at least one application program, according to the power reference parameter and an available power budget of the power providing device. At least one of the application programs listed in the candidate disabling list can be selected and disabled.

In view of above-mentioned embodiments, the application programs can be automatically disabled or the recommendation for disabling the application programs can be provided based on the power reference parameter input by the user. Accordingly, the user can efficiently disable application problems to increase run time of the power providing module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic apparatus applying the power managing method provided by the present disclosure.

FIG. 2 is a schematic diagram illustrating a power managing method according to one embodiment of the present disclosure.

FIG. 3 is a flow chart illustrating a power managing method according to one embodiment of the present disclosure.

FIG. 4-FIG. 6 are schematic diagrams illustrating more detail embodiments for the power managing method of the present disclosure.

FIG. 7 is a flowchart illustrating how to establish a database for application programs according to one embodiment of the present disclosure.

FIG. 8 is a flowchart illustrating how to decide an auto select list according to one embodiment of the present disclosure.

FIG. 9-FIG. 11 are schematic diagrams illustrating how to decide an auto select list based on the flow chart illustrated in FIG. 8.

### DETAILED DESCRIPTION

In the following, several embodiments are provided to explain the concept of the present disclosure. It will be appreciated that the system, the device, the apparatus or the module depicted in following embodiments can be implemented by hardware (ex. circuit) or the combination of hardware and software (ex. a processing unit executing at least one program). Also, the electronic apparatus illustrated below can be a portable electronic apparatus or a non-portable electronic apparatus.

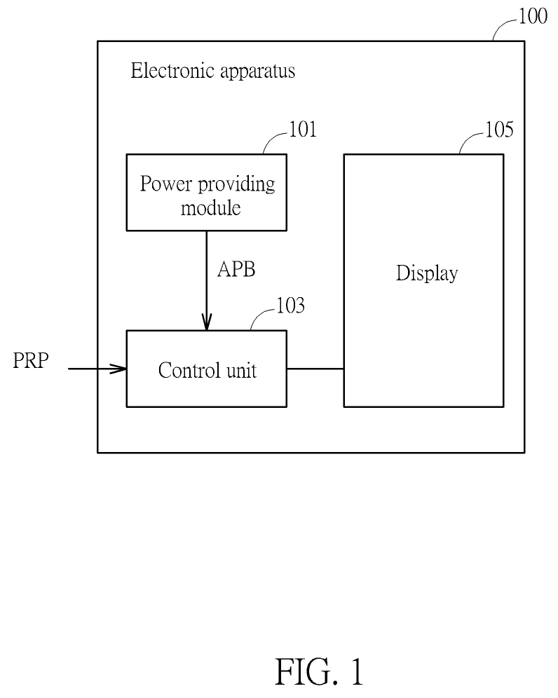

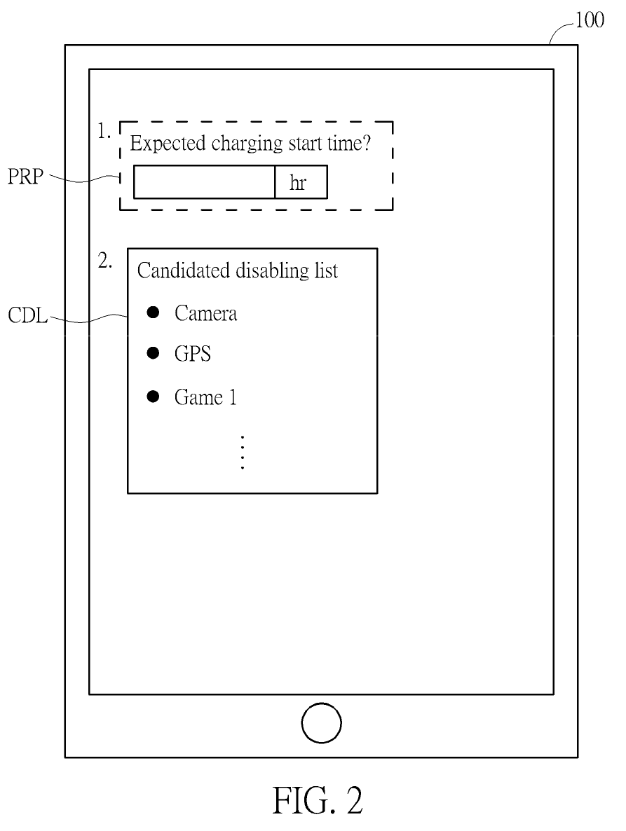

FIG. 1 is a block diagram illustrating an electronic apparatus applying the power managing method provided by the present disclosure. Also, FIG. 2 is a schematic diagram illustrating a power managing method according to one embodiment of the present disclosure. Please simultaneously refer FIG. 1 and FIG. 2 to understand the present disclosure for more clear.

As illustrated in FIG. 1, the electronic apparatus 100 comprises a power providing module 101, a control unit 103 and a display 105. The power providing module 101 is configured to provide power and comprises at least one battery in this embodiment. The control unit 103 is configured to compute the available power budget APB of the power providing module 101. Further, the control unit 103 receives a power reference parameter PRP provided by a user. Also, the control unit 103 controls the display 105 to display a candidate disabling list CDL, which lists at least one application program, according to the power reference parameter PRP and the available power budget APB of the power providing device. The user can select at least one of the application programs listed in the candidate disabling list CDL to disable the selected application program. Details for the candidate disabling list CDL will be described later.

The power reference parameter PRP can be input by various kinds of user interfaces, for example, a keyboard, a microphone or a touch screen. The power reference parameter PRP is a parameter which can be applied to decide the application programs listed in the candidate disabling list CDL. In following embodiments of the present disclosure, an expected charging start time is applied as an example for explaining. The expected charging start time means a time that the user expects the power providing module can be charged. For example, the user is outside and expects that he can back to his house one hour later, thus the user can type “1 hour” as the power reference parameter PRP in such case.

However, the power reference parameter PRP can be other parameters, for example, an operating mode or a power reserving ratio. The operating mode can be applied to decide the priority of application programs. For example, if the user selects a game mode, the application programs having no relations with games will be firstly listed in the candidate disabling list CDL, such as a camera, or a GPS. For another example, if the user selects a GPS mode, the application programs having no relations with GPS will be firstly listed in the candidate disabling list CDL, such as a game programs, a document reading program, or a browser. The power reserving ratio indicates the power that the user hopes to be reserved for a specific time interval. For example, the user hopes to reserve 50% power of the power providing module for a meeting two hours later, in such case the user can input “50%, 2 hours” as the power reference parameter PRP.

Please note the power reference parameter PRP is not limited to a single kind of parameters. For example, the user can input both the expected charging start time and the operating mode as the power reference parameter PRP.

The application programs can indicate each device of the electronic apparatus, for example, a camera, a flashlight, a g-sensor or a GPS. Also, the application programs can indicate any program installed in the electronic apparatus, for example, a game program, a photo editing program or a document reading program.

Additionally, the available power budget APB indicates the power amount can be allocated to the application programs. The available power budget APB can be decided according to, for example, the total power budget and the system demand budget, as illustrated in earlier application with a Ser. No. 14/937,895. However, the available power budget APB is not limited to be acquired according to these methods.

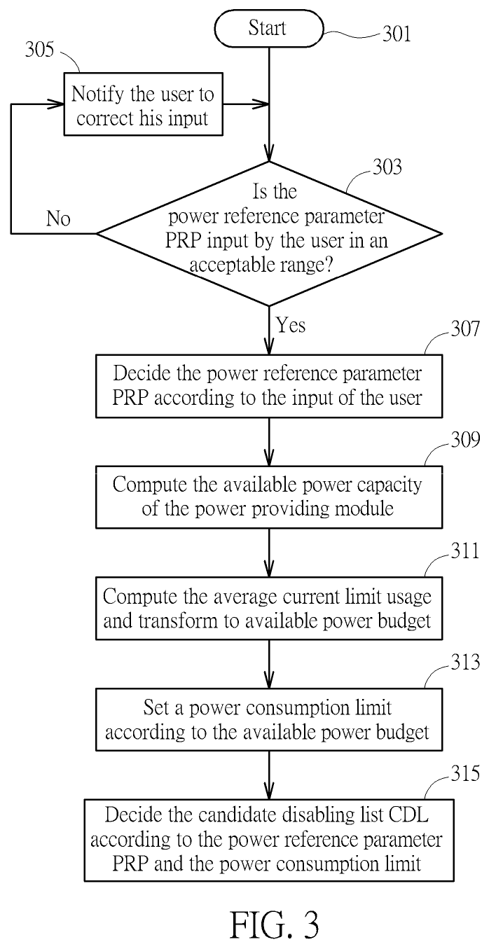

FIG. 3 is a flow chart illustrating a power managing method according to one embodiment of the present disclosure. That is, FIG. 3 is an example summarizing the operations illustrated in FIG. 1 and FIG. 2. FIG. 3 comprises following steps:

Step 301

Start.

Step 303

Check if the power reference parameter PRP input by the user is in an acceptable range? If not, go to step 305. On the opposite, go to step 307.

For example, the power reference parameter PRP is an expected charging start time and the acceptable range is set 0-72 hours. In such case, if the user inputs 1000 hours as the power reference parameter PRP, such power reference parameter PRP is not in the acceptable range. On the opposite, if the user inputs 1 hour as the power reference parameter PRP, such power reference parameter PRP is in the acceptable range.

Step 305

Notify the user to correct his input.

In one embodiment, the steps 303, 305 can be removed.

Step 307

Decide the power reference parameter PRP according to the input of the user.

Step 309

Compute the available power capacity of the power providing module.

Step 311

Compute the average current limit usage and transform to available power budget.

Step 313

Set a power consumption limit according to the available power budget.

Step 3115

Decide the candidate disabling list CDL according to the power reference parameter PRP and the power consumption limit.

For example, the candidate disabling list CDL lists more application programs if the power reference parameter PRP is larger and the power consumption limit is lower.

The following is an example for steps 309-313.

If the max power capacity that the power providing module can provide is 2400 mah but only has current power for 30%, the available power capacity in the step 309 is 720 mah. If the user sets the power reference parameter PRP as 12 hours, the average current limit usage for each hour in the step 311 is 720 mah/12 h=60 mA. Accordingly, the available power budget in the step 313 is 60 mA*VBAT (the voltage that the power providing module can provide). Therefore, the power consumption limit in the step 309 is set according to 60 mA*VBAT.

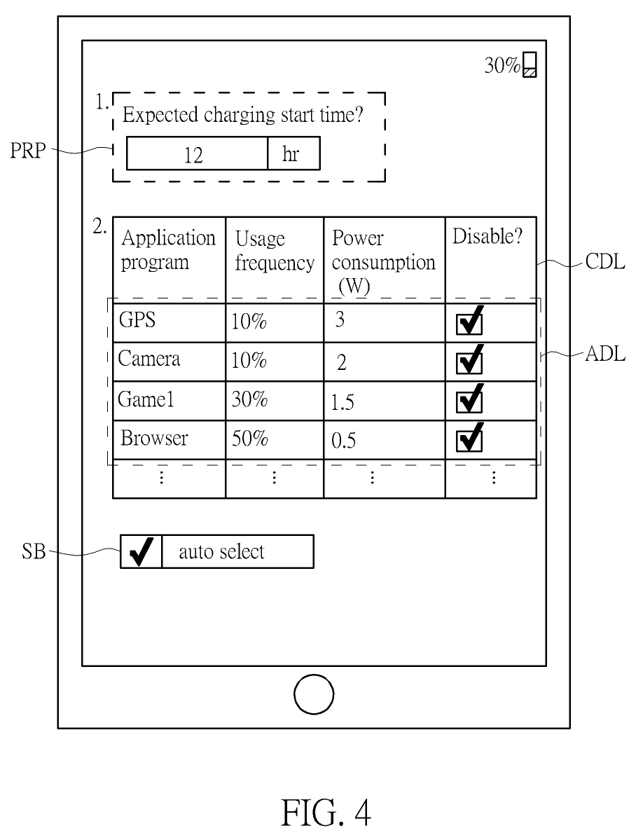

FIG. 4-FIG. 6 are schematic diagrams illustrating more detail embodiments for the power managing method. As illustrated in FIG. 4, the available power capacity is 30% of the max power capacity. Also, the power reference parameter PRP is 12 hours, and the candidate disabling list CDL is decided according to the power reference parameter PRP and the available power capacity. In the embodiment of FIG. 4, the candidate disabling list CDL further comprises usage frequencies of the application programs and power consumptions of the application programs. It will be appreciated that the candidate disabling list CDL can comprise only one of the application programs and power consumptions of the application programs. Therefore, the candidate disabling list CDL can be decided according to the usage frequencies or the power consumptions besides the available power capacity and the power reference parameter PRP. For example, the candidate disabling list CDL firstly list the application program having a lowest usage frequency or a highest power consumption.

Also, in the embodiment of FIG. 4, the candidate disabling list CDL further comprises an auto select list ADL which comprises the application programs GPS, camera, Game 1 and Browser. The application programs in the auto select list ADL will be disabled automatically. The user can select if the application programs can be disabled automatically or not, for example, via the selecting block SB.

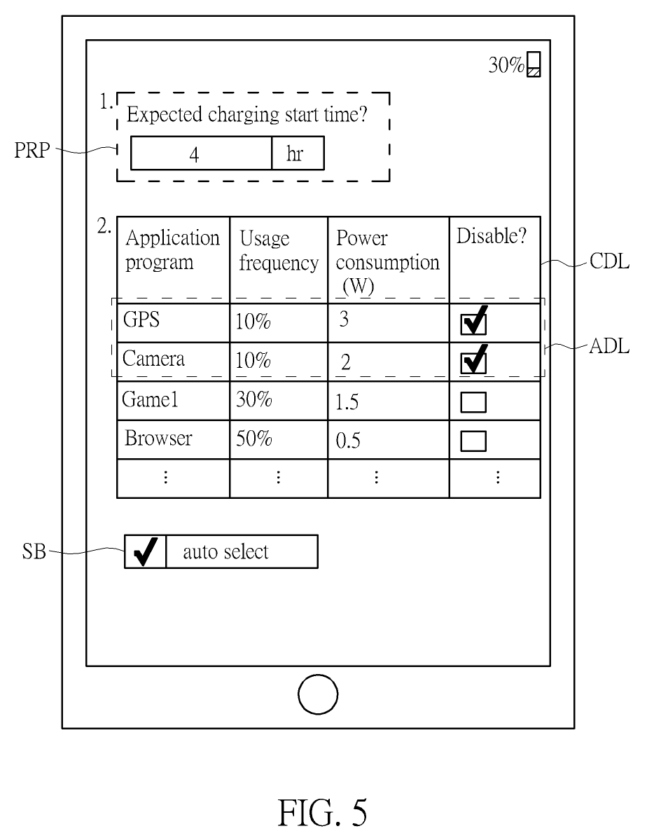

In the embodiment of FIG. 5, the power reference parameter PRP is 4 hours, thus the available power budget per hour is larger than the embodiment of FIG. 4. Therefore, the number of the application programs in the auto select list ADL is fewer than which for the embodiment of FIG. 4. That is, the auto select list ADL in the embodiment of FIG. 5 only comprises two application programs: GPS and camera. Please note, in the embodiments of FIG. 4 and FIG. 5, the auto select list ADL and the application programs not in the auto select list ADL are included in a single candidate disabling list CDL. However, in one embodiment the auto select list ADL and the application programs not in the auto select list ADL are listed in two independent lists. Take FIG. 5 for example, the GPS and camera are listed in one list, but the Game 1, the Browser are listed in another list.

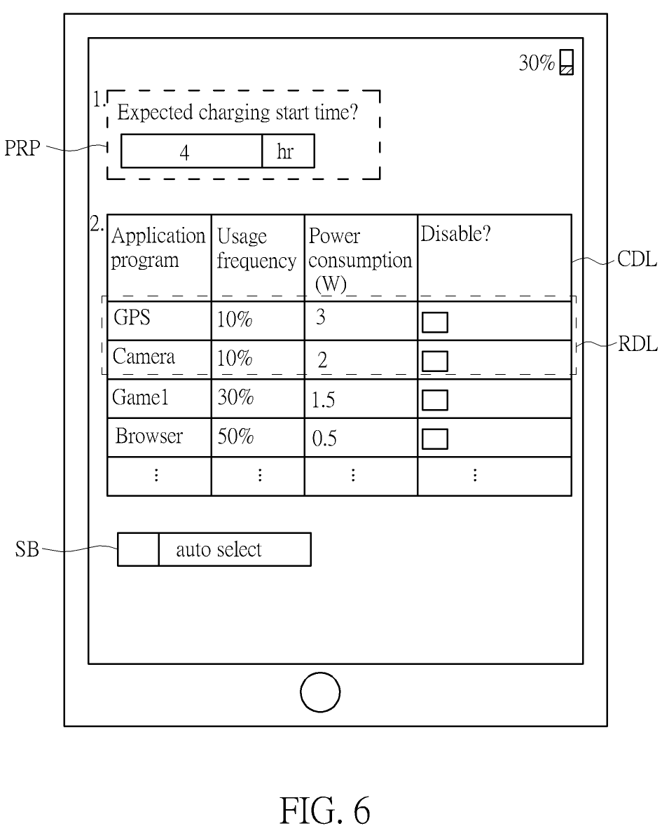

In the embodiment of FIG. 6, the candidate disabling list CDL further comprises a recommended disabling list RDL. The recommended disabling list RDL lists the application programs which are recommended to be disable. The steps for deciding the auto select list ADL or the recommended disabling list RDL will be described later. Please note, the steps for deciding the auto select list ADL and the recommended disabling list RDL can be performed by the control unit 103 in FIG. 1 as well.

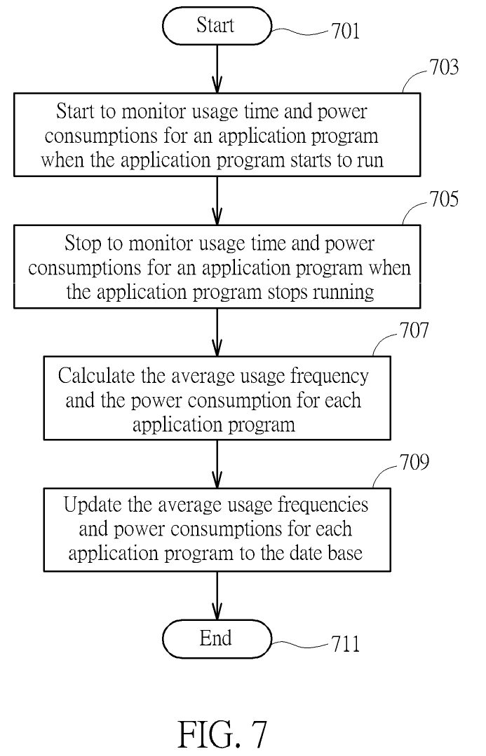

As illustrated in the embodiments of FIG. 4-FIG. 6, the candidate disabling list CDL comprises usage frequencies and the power consumptions for application programs. The usage frequencies and the power consumptions can be acquired from a data base for application programs. FIG. 7 is a flow chart illustrating how to establish a data base for application programs according to one embodiment of the present disclosure. FIG. 7 comprises following steps:

Step 701

Start

Step 703

Start to monitor usage time and power consumptions for an application program when the application program starts to run.

Step 705

Stop to monitor usage time and power consumptions for an application program when the application program stops running.

Step 707

Calculate the average usage frequency and the power consumption for each application program.

Step 709

Update the average usage frequencies and power consumptions for each application program to the date base.

Step 711

End.

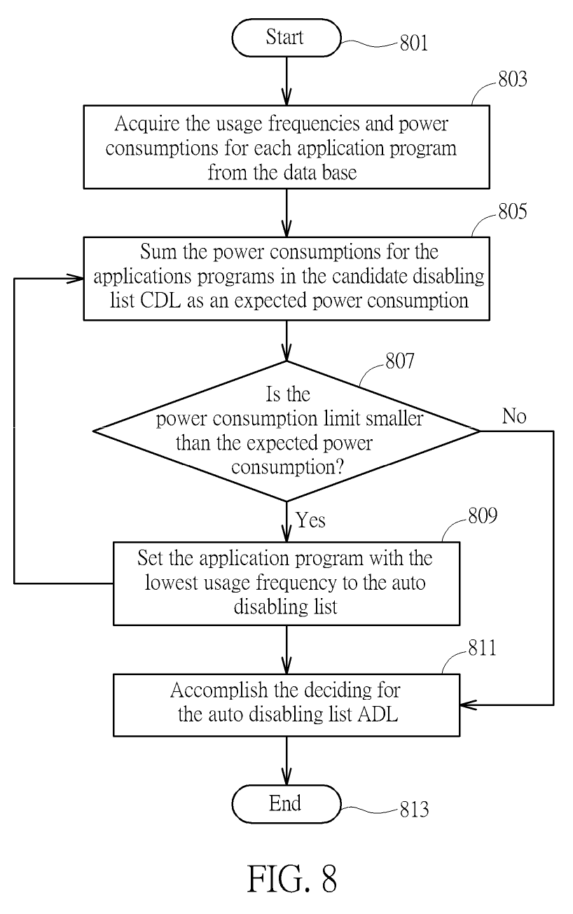

Moreover, in the embodiments of FIG. 8-FIG. 11, details for deciding the auto select list are illustrated. It will be appreciated the embodiments of FIG. 8-FIG. 11 can be applied to decide the recommended disabling list RDL as well.

FIG. 8 is a flowchart illustrating how to decide an auto select list according to one embodiment of the present disclosure. FIG. 8 comprises following steps:

Step 801

Start.

Step 803

Acquire the usage frequencies and power consumptions for each application program from the data base.

Step 805

Sum the power consumptions for the applications programs in the candidate disabling list CDL as an expected power consumption.

Step 807

Is the power consumption limit, which is generated based on available power budget as illustrated in FIG. 3, smaller than the expected power consumption?

If yes, it means the power consumption for the applications programs in the candidate disabling list CDL is too large, thus go to step 809 to lists at least one application program in the candidate disabling list CDL to the auto select list ADL.

On the contrary, if not, it means the power consumption for the application programs is acceptable, thus go to step 811 to accomplish the auto select list ADL.

Step 809

List the application program with the lowest usage frequency in the auto select list. Please note, this step can be changed to “list the application program with a highest power consumption in the auto select list”.

Step 811

Accomplish the deciding for the auto select list ADL.

Step 813

End.

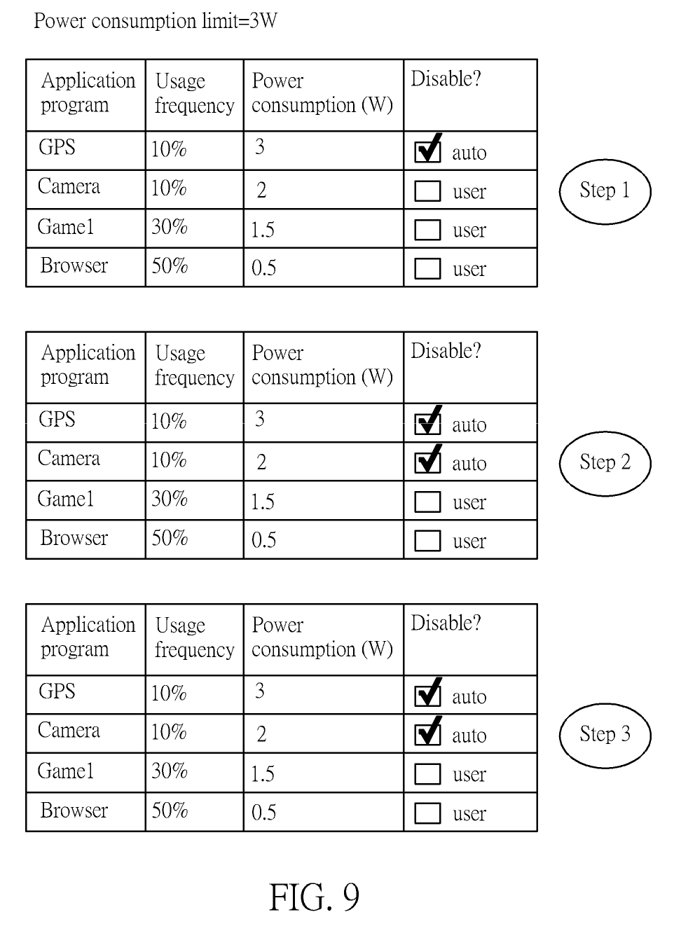

FIG. 9-FIG. 11 are schematic diagrams illustrating how to decide an auto select list based on the flow chart illustrated in FIG. 8. Also, the example in FIG. 9 further corresponds the embodiment illustrated in FIG. 5. In the example of FIG. 9, the power consumption limit based on the available power budget is 3 W, and no application programs are initially in the auto select list ADL. Corresponding to the steps 803, 805 in FIG. 8, the power consumptions for each application program are acquired and summed to generate the expected power consumption (7 W in the example of FIG. 9). After that, the expected power consumption (7 W) is compared with the power consumption limit (3 W), corresponding to the step 807 in FIG. 8.

Then, in the step 1 of FIG. 9, the expected power consumption (7 W) is larger than the power consumption limit (3 W), thus the GPS with a lowest usage frequency and a largest power consumption is listed in the auto select list and disabled (step 809 in FIG. 8). After the step 1 of FIG. 9, the expected power consumption is changed to 4 W (Camera+Game1+Browser), corresponding to the step 805 in FIG. 8. However, the expected power consumption (4 W) is stiller larger than the power consumption limit (3 W), thus the Camera with a lowest usage frequency and a largest power consumption is listed in the auto select list and disabled (step 809 in FIG. 8). After that, the expected power consumption is changed to 2 W (Game1+Browser). Next, the expected power consumption (2 W) is smaller than the power consumption limit (3 W), thus the auto select list is decided and updated to the candidate disabling list CDL (Step 811 in FIG. 8).

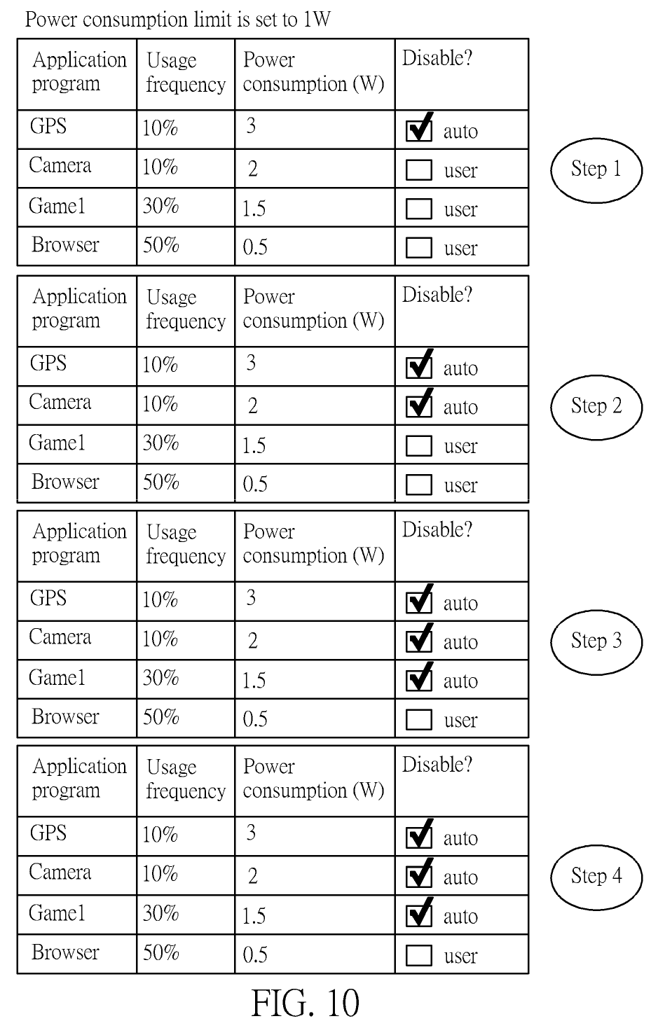

In above-mentioned embodiments, the power consumption limit is decided based on the available power budget. In other embodiments, the power consumption limit can be set to a predetermined power consumption limit. In the embodiment of FIG. 10, the power consumption limit is set to 1 W to make sure the power providing module has a longer run time. Therefore, the steps 1, 2, 3 of FIG. 10 sequentially disable the GPS, the Camera and the Game 1 according to the steps 805-809 in FIG. 8. After that, in the step 4 of FIG. 10, the expected power consumption (0.5 W) is smaller than the power consumption limit (1 W), thus the auto select list is decided and updated to the candidate disabling list CDL.

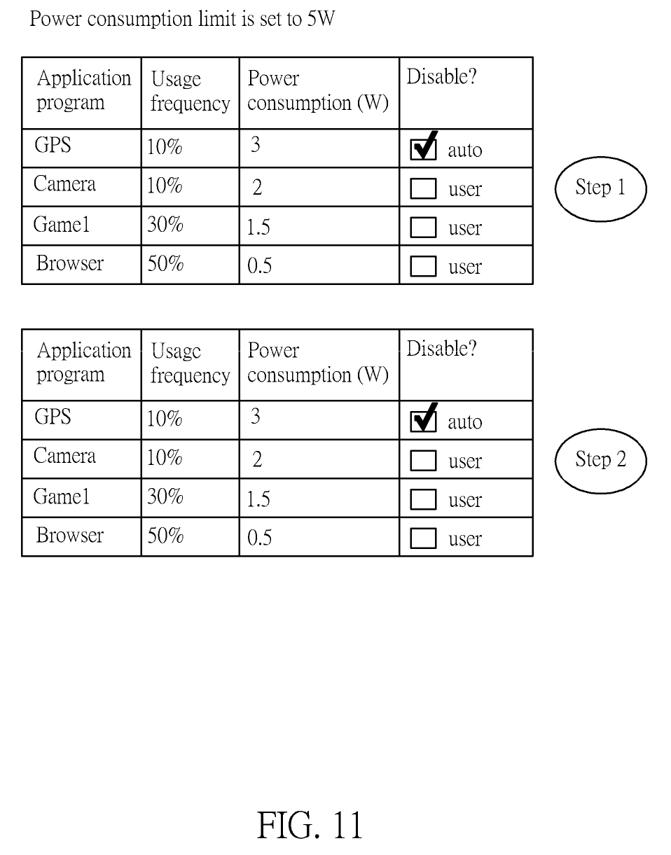

In the embodiment of FIG. 11, the power consumption limit is set to 4 W since the user cares about the number of functions that the application programs can provide more than run time of the power providing module. Accordingly, the step 1 of FIG. 11 disables the GPS according to the steps 805-809 in FIG. 8. After that, in the step 2 of FIG. 11, the expected power consumption (4 W) is smaller than the power consumption limit (5 W), thus the auto select list is decided and updated to the candidate disabling list CDL. In such embodiment, the performance for each application program can be set lower such that the power providing device can have a longer run time.

In view of above-mentioned embodiments, the application programs can be automatically disabled or the recommendation for disabling the application programs can be provided based on the power reference parameter input by the user. Accordingly, the user can efficiently disable application problems to increase run time of the power providing module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power managing method, applied to an electronic system comprising a power providing device, comprising:
(a) receiving a power reference parameter provided by a user; and
(b) displaying a candidate disabling list, which lists at least one application program, according to the power reference parameter and an available power budget of the power providing device;
wherein at least one of the application programs listed in the candidate disabling list can be selected and disabled.

2. The power managing method of claim 1, wherein the power reference parameter comprises at least following parameter: an operating mode or a power reserving ratio.

3. The power managing method of claim 1, wherein the power reference parameter is an expected charging start time.

4. The power managing method of claim 1, wherein the candidate disabling list comprises a usage frequency of the application program or a power consumption of the application program.

5. The power managing method of claim 1, wherein the candidate disabling list comprises a recommended disabling list.

6. The power managing method of claim 1, wherein the candidate disabling list comprises an auto select list.

7. The power managing method of claim 6, wherein the power managing method comprises:
(c) summing power consumptions for the application programs in the candidate disabling list as an expected power consumption;
(d) listing the application programs in the candidate disabling list to the auto select list according to the expected power consumption, and the available power budget.

8. The power managing method of claim 7, wherein the candidate disabling list further comprises a usage frequency of the application program, wherein the step (d) comprises:
(d1) comparing the expected power consumption with a power consumption limit generated based on the available power budget; and
(d2) if the expected power consumption is larger than the power consumption limit, listing the application program with a lowest usage frequency in the auto select list.

9. The power managing method of claim 7, further comprising:
(e) setting a desired power consumption limit to the electronic system; and
(f) listing the application programs in the candidate disabling list to the auto select list according to the expected power consumption, and the desired power consumption limit.

10. The power managing method of claim 9, further comprising:
setting performances for each application program to be lower if the desired power consumption limit is larger than a power consumption limit generated based on the available power budget.

11. An electronic apparatus, comprising:
a power providing device; and
a control unit, configured to receive a power reference parameter provided by a user, and configured to control a display to display a candidate disabling list, which lists at least one application program, according to the power reference parameter and an available power budget of the power providing device;
wherein at least one of the application programs listed in the candidate disabling list can be selected and disabled.

12. The electronic apparatus of claim 11, wherein the power reference parameter comprises at least following parameter: an operating mode or a power reserving ratio.

13. The electronic apparatus of claim 11, wherein the power reference parameter is an expected charging start time.

14. The electronic apparatus of claim 11, wherein the candidate disabling list comprises a usage frequency of the application program or a power consumption of the application program.

15. The electronic apparatus of claim 11, wherein the candidate disabling list comprises a recommended disabling list.

16. The electronic apparatus of claim 11, wherein the candidate disabling list comprises an auto select list.

17. The electronic apparatus of claim 16, wherein the control unit is further configured to perform following steps:
(c) summing power consumptions for the application programs in the candidate disabling list as an expected power consumption;
(d) listing the application programs in the candidate disabling list to the auto select list according to the expected power consumption, and the available power budget.

18. The electronic apparatus of claim 17, wherein the candidate disabling list further comprises a usage frequency of the application program, wherein the step (d) comprises:
(d1) comparing the expected power consumption with a power consumption limit generated based on the available power budget; and
(d2) if the expected power consumption is larger than the power consumption limit, listing the application program with a lowest usage frequency in the auto select list.

19. The electronic apparatus of claim 17, wherein the control unit is further configured to perform following steps:
(e) setting a desired power consumption limit to the electronic system; and
(f) listing the application programs in the candidate disabling list to the auto select list according to the expected power consumption, and the desired power consumption limit.

20. The electronic apparatus of claim 19, wherein the control unit is further configured to perform a following step:
setting performances for each application program to be lower if the desired power consumption limit is larger than a power consumption limit generated based on the available power budget.
